(19) United States
(12) Patent Application Publication
(10) Pub. No.: US 2026/0174009 A1
(43) Pub. Date: Jun. 25, 2026

(54) LAWN MOWER BODY STRUCTURE AND LAWN MOWER

(71) Applicant: ZHEJIANG TITAN MACHINERY CO., LTD., Jinhua City (CN)

(72) Inventors: Xiaofeng Guo, Jinhua City (CN); May Cao, Jinhua City (CN)

(73) Assignee: ZHEJIANG TITAN MACHINERY CO., LTD., Jinhua City (CN)

(21) Appl. No.: 19/280,296

(22) Filed: Jul. 25, 2025

(30) Foreign Application Priority Data
Dec. 23, 2024 (CN) 2024231872551

(51) Int. Cl. A01D 34/90; A01D 34/416; A01D 101/00

(52) U.S. Cl. CPC A01D 34/90; A01D 34/416; A01D 2101/00

(57) ABSTRACT

The present disclosure provides a lawn mower body structure and a lawn mower, and relates to the technical field of weeding devices. The lawn mower body structure includes the control handle, the first rod body, the second rod body, and the third rod body, wherein one end of the first rod body is connected to the control handle, and the other end is connected to the second rod body via the quick locking member; one end of the second rod body away from the first rod body is connected to the third rod body via the fixed locking member; and one end of the third rod body away from the second rod body can connect to the lawn mower head of the lawn mower.

### CROSS-REFERENCE TO RELATED APPLICATION

The present disclosure claims priority to Chinese patent application No. 2024231872551, filed with the Chinese Patent Office on Dec. 23, 2024, the entire contents of which are incorporated herein by reference.

### TECHNICAL FIELD

The present disclosure relates to the technical field of weeding devices, and specifically to a lawn mower body structure and a lawn mower.

### BACKGROUND ART

The lawn mower, also known as a weed cutter or a brush cutter, is a tool used to trim lawns and vegetation, most of which use motors to drive the blades to rotate to trim the vegetation. Common lawn mowers are mostly handheld, making them suitable for various different grounds and resistant to damage from debris on the ground.

Various scenarios such as urban greening require the use of electric garden tools such as lawn mowers, which are widely used in trimming for the lawn and garden. It can greatly reduce the labor intensity of horticultural personnel and save labor costs.

However, the length of the volume of the lawn mower is larger, and the space occupied in the storage or transportation process is larger, which increases the cost of storage or transportation. Moreover, when the lawn mower is operated in a narrow space, the workers have limited room for movement, and it is not easy to operate.

### SUMMARY

The objective of the present disclosure is to provide a lawn mower body structure and a lawn mower to solve the technical problem of inconvenient storage of the lawn mower in the prior art.

In a first aspect, the embodiments of the present disclosure provide a lawn mower body structure, including a control handle, a first rod body, a second rod body, and a third rod body, wherein
one end of the first rod body is connected to the control handle, and the other end is connected to the second rod body via a quick locking member;
one end of the second rod body away from the first rod body is connected to the third rod body via a fixed locking member; and
one end of the third rod body away from the second rod body can connect to a lawn mower head of the lawn mower.

In conjunction with the first aspect, the embodiments of the present disclosure provide a possible implementation of the first aspect, wherein the above quick locking member includes a first elastic locking sleeve and an eccentric handle.

The first elastic locking sleeve is provided with a first hole and a second hole, wherein the first hole and the second hole are communicated and can pass through the first elastic locking sleeve in an axial direction of the first elastic locking sleeve, and a diameter of the first hole is larger than a diameter of the second hole.

The first rod body is inserted in the first hole, the second rod body is inserted in the second hole, and an outer diameter of the second rod body is not larger than an inner diameter of the first rod body.

A first locking base is arranged on an outer wall of the first elastic locking sleeve located at the first hole, and a second locking base is arranged on an outer wall of the first elastic locking sleeve located at the second hole, wherein two sides of the first locking base are locked by a bolt, and the eccentric handle is mounted on the second locking base by a bolt, so that the eccentric handle can control locking of the second locking base.

In conjunction with the first aspect, the embodiments of the present disclosure provide a possible implementation of the first aspect, wherein a limiting sleeve is arranged on one end of the second rod body inserted in the second hole; a limit retaining ring is arranged on an outer ring of the limiting sleeve; an outer diameter of the limit retaining ring is larger than an inner diameter of the second hole; and the limit retaining ring is located in the first hole.

In conjunction with the first aspect, the embodiments of the present disclosure provide a possible implementation of the first aspect, wherein a limit snapping hole is arranged on a side wall of the second rod body, and the limit retaining ring is provided with an elastic snapping block, which can be snapped with the limit snapping hole.

In conjunction with the first aspect, the embodiments of the present disclosure provide a possible implementation of the first aspect, wherein a first positioning block and a first positioning guide rail are arranged on an inner wall of the above first elastic locking sleeve;

A first positioning groove adapted to the first positioning block is arranged on an end part of the first rod body.

A guide slot adapted to the first positioning guide rail is arranged on an outer wall of the second rod body.

In conjunction with the first aspect, the embodiment of the present disclosure provides a possible embodiment of the first aspect, wherein the above fixed locking member includes a second elastic locking sleeve and a locking bolt.

A third hole is arranged on the second elastic locking sleeve along its axial direction; a third locking base is arranged on an outer wall of the second elastic locking sleeve; and the third locking base is locked by the locking bolt.

In conjunction with the first aspect, the embodiment of the present disclosure provides a possible embodiment of the first aspect, wherein a second positioning block and a second positioning guide rail are arranged on an inner wall of the above second elastic locking sleeve.

Second positioning grooves adapted to the second positioning block are arranged on end parts of the second rod body and the third rod body.

A guide slot of the second rod body can be adapted to the second positioning guide rail, and the guide slot is arranged on an outer wall of the third rod body.

In conjunction with the first aspect, the embodiment of the present disclosure provides a possible embodiment of the first aspect, wherein an adjustable rotating member is arranged in the above control handle, and one end of the first rod body away from the quick locking member is connected to the adjustable rotating member.

In conjunction with the first aspect, the embodiment of the present disclosure provides a possible embodiment of the first aspect, wherein the above adjustable rotating member includes a locking ring, a locking button, a locking spring, and a locking sleeve.

The locking sleeve is arranged on an end part of the first rod body; the locking ring is sleeved on an outer wall of the locking sleeve; the locking sleeve is provided with a plurality of anti-rotation holes; and an inner ring of the locking ring is provided with an anti-rotation block adapted to the anti-rotation holes.

The locking button is arranged on a top of the locking ring, and the locking button protrudes from the control handle.

The locking spring is located at a bottom of the locking ring, wherein one end of the locking spring abuts against the locking ring, and the other end abuts against an inner wall of the control handle.

A bearing groove configured for bearing the locking spring is arranged on the inner wall of the control handle, and a positioning post is arranged at a bottom of the locking ring.

Guide slot plates are arranged on the inner wall of the control handle, and the locking ring is arranged between two guide slot plates, so that the locking ring can slide up and down along a sliding groove between the two guide slot plates.

In a second aspect, the embodiments of the present disclosure provide a lawn mower, including the lawn mower body structure.

The present disclosure includes the following beneficial effects.

The present disclosure provides a lawn mower body structure, including the control handle, the first rod body, the second rod body, and the third rod body, wherein one end of the first rod body is connected to the control handle, and the other end is connected to the second rod body via the quick locking member; one end of the second rod body away from the first rod body is connected to the third rod body via the fixed locking member; and one end of the third rod body away from the second rod body can connect to the lawn mower head of the lawn mower.

Specifically, during the storage or transportation process of the lawn mower, the staff can quickly disassemble the lawn mower body into a three-section structure by the quick locking member and the fixed locking member, and then the three-section structure is folded for storage, where the folding is performed in an S-shaped manner, which does not affect lines within the rod body. This greatly reduces the volume of the lawn mower and facilitates the storage and transportation. Additionally, during use, the users can adjust the length of the machine body according to their heights. Specifically, the user releases the connection between the first rod body and the second rod body by the quick locking member, so that the expansion and contraction of the second rod body can be adjusted relative to the first rod body to satisfy the needs of users of different heights.

The present disclosure provides a lawn mower, including a lawn mower body structure. The lawn mower has the above advantages compared with the prior art, which will not be repeated herein.

### BRIEF DESCRIPTION OF DRAWINGS

In order to more clearly illustrate the technical solutions in the embodiments of the present disclosure or in the prior art, the drawings to be used in the description of the embodiments or prior art will be briefly introduced below. It is obvious that the drawings in the following description are some embodiments of the present disclosure. For a person of ordinary skill in the art, other drawings can be obtained based on these drawings without inventive efforts.

FIG. 1 shows a schematic diagram of a lawn mower body structure mounted on a lawn mower provided by the embodiments of the present disclosure;

FIG. 2 shows a schematic diagram of a connection between a control handle and a first rod body in a lawn mower body structure provided by the embodiments of the present disclosure;

FIG. 3 shows an internal schematic diagram of a control handle in a lawn mower body structure provided by the embodiments of the present disclosure;

FIG. 4 shows a schematic diagram of an adjustable rotating member and a first rod body in a lawn mower body structure provided by the embodiments of the present disclosure;

FIG. 5 shows a partial schematic diagram of an adjustable rotating member in a lawn mower body structure provided by the embodiments of the present disclosure;

FIG. 6 shows a schematic diagram of a locking ring in a lawn mower body structure provided by the embodiments of the present disclosure;

FIG. 7 shows a schematic diagram of a quick locking member, a first rod body, and a second rod body in a lawn mower body structure provided by the embodiments of the present disclosure;

FIG. 8 shows a sectional diagram of a quick locking member, a first rod body, and a second rod body in a lawn mower body structure provided by the embodiments of the present disclosure;

FIG. 9 shows a schematic diagram of a quick locking member and a first rod body in a lawn mower body structure provided by the embodiment of the present disclosure;

FIG. 10 shows a partial schematic diagram of a second rod body in a lawn mower body structure provided by the embodiments of the present disclosure; and

FIG. 11 shows a schematic diagram of a third rod body and a fixed locking member in a lawn mower body structure provided by the embodiments of the present disclosure.

### REFERENCE NUMBERS

100—control handle; 110—adjustable rotating member; 111—locking ring; 112—locking button; 113—locking spring; 114—locking sleeve; 115—anti-rotation hole; 116—anti-rotation block; 117—positioning post; 120—bearing groove; 130—guide slot plate;
200—first rod body; 210—first positioning groove;
300—second rod body; 310—limiting sleeve; 311—limit retaining ring; 312—elastic snapping block; 320—limit snapping hole; 330—guide slot;
400—third rod body; 410—second positioning groove;
500—quick locking member; 510—first elastic locking sleeve; 511—first hole; 512—second hole; 513—first locking base; 514—second locking base; 520—eccentric handle; 530—first positioning block; 540—first positioning guide rail;
600—fixed locking member; 610—second elastic locking sleeve; 611—third hole; 612—third locking base; 620—locking bolt; 630—second positioning block; 640—second positioning guide rail;
700—lawn mower head.

### DETAILED DESCRIPTION OF EMBODIMENTS

The technical solutions of the present disclosure will be clearly and completely described below in conjunction with the drawings. It is clear that the embodiments described are only partial embodiments of the present disclosure, and not all of the embodiments. Based on the embodiments in the present disclosure, all other embodiments obtained by a person of ordinary skill in the art without inventive efforts shall fall within the scope of protection of the present disclosure.

In the description of the present disclosure, it is to be understood that orientation or positional relationships indicated by terms, such as “center”, “longitudinal”, “transverse”, “length”, “width”, “thickness”, “up”, “down”, “front”, “back”, “left”, “right”, “vertical”, “horizontal”, “top”, “bottom” “inside”, “outside”, “clockwise”, “counterclockwise”, “axial”, “radial”, and “circumferential” are the orientation or positional relationships based on the drawings, which are only to facilitate the description of the present disclosure and simplify the description, and are not to indicate or imply that the device or element referred to must have a particular orientation, or be constructed and operated with a particular orientation, and are not to be understood as limitations of the present disclosure.

Additionally, the terms “first” and “second” are used only for descriptions and are not to be understood as indicating or implying a relative importance or implicitly specifying the number of technical features indicated. Therefore, a feature defined by “first” or “second” can expressly or implicitly include one or more such features. In the description of the present disclosure, “plurality” means two or more, unless otherwise expressly and specifically limited.

In the present disclosure, unless other express specifications and limitations, the terms “mount”, “connect”, “interconnect”, and “fix” are to be understood in a broad sense. For example, it can be a fixed connection, a detachable connection, or an integral; it can be a mechanical connection or an electrical connection; it can be a direct connection, an indirect connection through an intermediate medium; and it can be a communication inside two components or interaction relationships between two components. For a person of ordinary skill in the art, the specific meaning of the above terms in the present disclosure may be understood according to specific situations.

The present disclosure is described in further detail below by specific embodiments in conjunction with drawings.

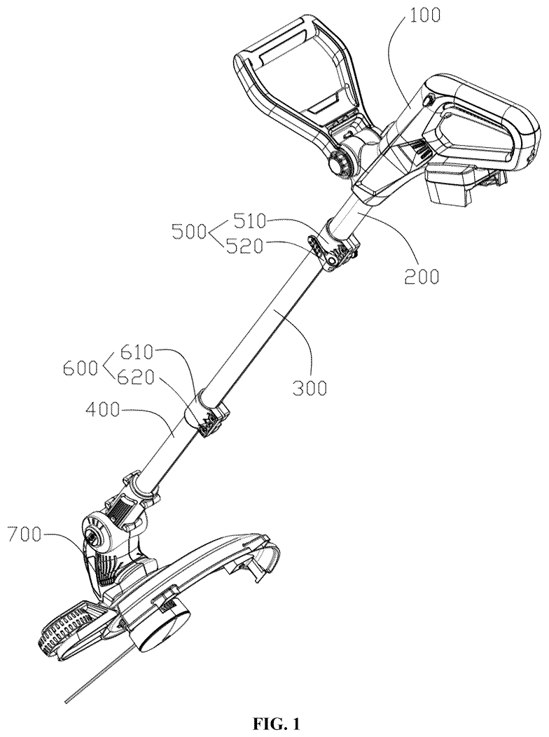

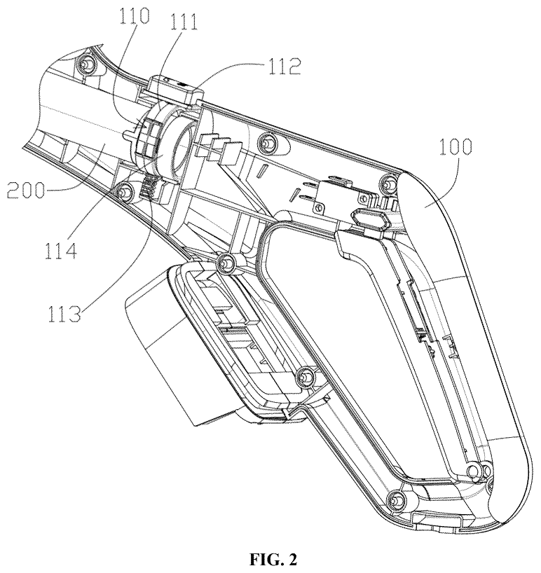

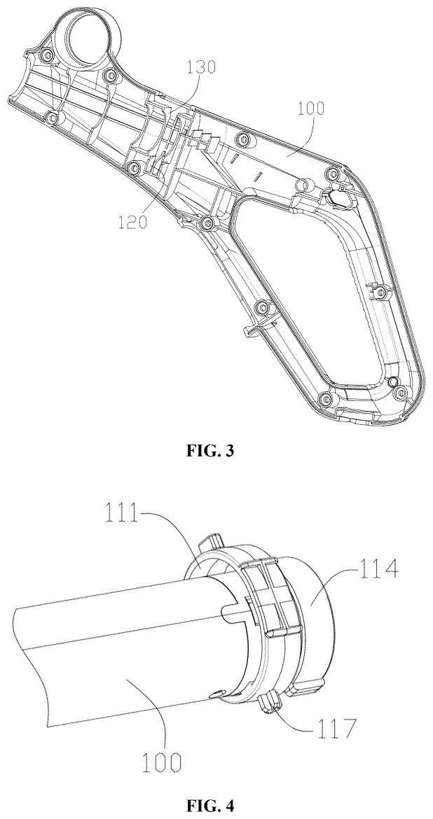

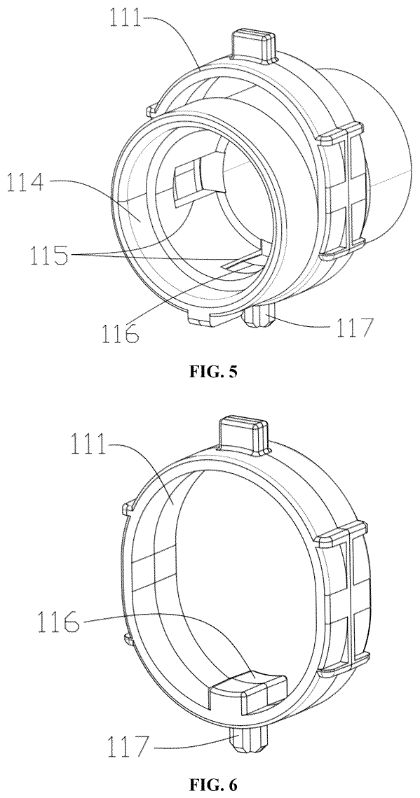

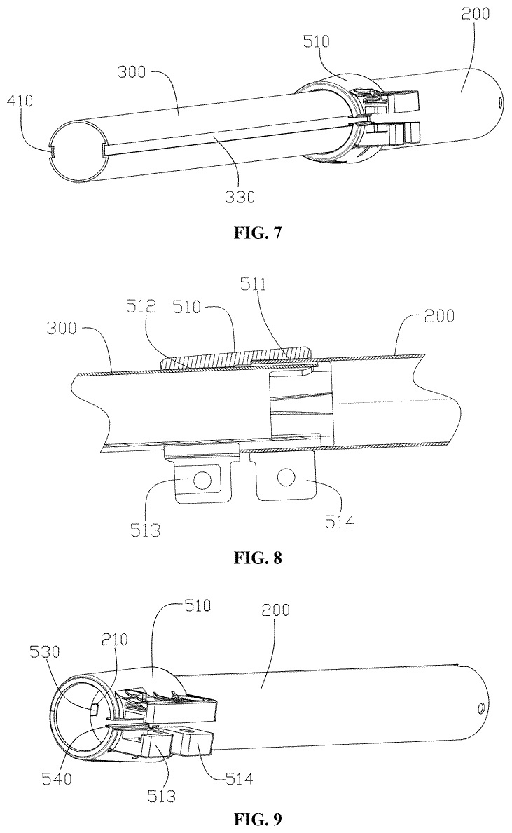

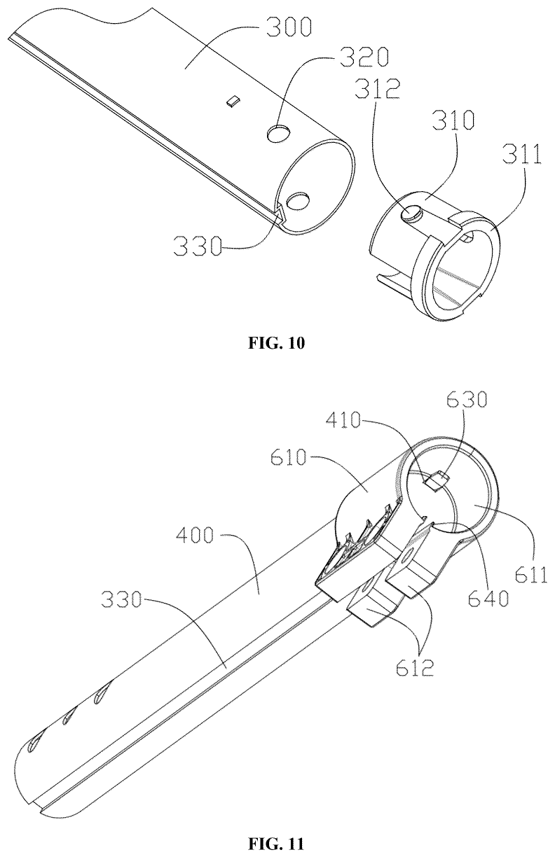

Referring to FIG. 1, FIG. 2, FIG. 3, FIG. 4, FIG. 5, FIG. 6, FIG. 7, FIG. 8, FIG. 9, FIG. 10, and FIG. 11, the embodiment provides a lawn mower body structure, including a control handle 100, a first rod body 200, a second rod body 300, and a third rod body 400, wherein one end of the first rod body 200 is connected to the control handle 100, and the other end is connected to the second rod body 300 via the quick locking member 500; one end of the second rod body 300 away from the first rod body 200 is connected to the third rod body 400 via the fixed locking member 600; and one end of the third rod body 400 away from the second rod body 300 can connect to the lawn mower head 700 of the lawn mower.

Specifically, during the storage or transportation process of the lawn mower, the staff can quickly disassemble the lawn mower body into a three-section structure by the quick locking member 500 and the fixed locking member 600, and then the three-section structure is folded for storage, where the folding is performed in an S-shaped manner, which does not affect circuits within the rod body. This greatly reduces the volume of the lawn mower and facilitates the storage and transportation. Additionally, during use, the users can adjust the length of the machine body according to their heights. Specifically, the user releases the connection between the first rod body 200 and the second rod body 300 by the quick locking member 500, so that the expansion and contraction of the second rod body 300 can be adjusted relative to the first rod body 200 to satisfy needs of users of different heights.

Referring to FIG. 1-FIG. 11, in an optional solution of the embodiment, the quick locking member 500 includes a first elastic locking sleeve 510 and an eccentric handle 520; the first elastic locking sleeve 510 is provided with a first hole 511 and a second hole 512, wherein the first hole 511 and the second hole 512 are communicated and can pass through the first elastic locking sleeve 510 in an axial direction of the first elastic locking sleeve 510, and a diameter of the first hole 511 is larger than a diameter of the second hole 512. The first rod body 200 is inserted in the first hole 511; the second rod body 300 is inserted in the second hole 512; and an outer diameter of the second rod body 300 is not larger than an inner diameter of the first rod body 200. A first locking base 513 is arranged on an outer wall of the first elastic locking sleeve 510 located at the first hole 511, and a second locking base 514 is arranged on an outer wall of the first elastic locking sleeve 510 located at the second hole 512, wherein two sides of the first locking base 513 are locked by bolts. The eccentric handle 520 is mounted on the second locking base 514 by the bolts so that the eccentric handle 520 can control the locking of the second locking base 514.

A limiting sleeve 310 is arranged on one end of the second rod body 300 inserted in the second hole 512; a limit retaining ring 311 is arranged on an outer ring of the limiting sleeve 310; an outer diameter of the limit retaining ring 311 is larger than an inner diameter of the second hole 512; and the limit retaining ring 311 is located in the first hole 511.

A limit snapping hole 320 is arranged on a side wall of the second rod body 300. The limit retaining ring 311 is provided with an elastic snapping block 312, which can snap with the limit snapping hole 320.

A first positioning block 530 and a first positioning guide rail 540 are arranged on an inner wall of the first elastic locking sleeve 510; a first positioning groove 210 adapted to the first positioning block 530 is arranged on an end part of the first rod body 200, and a guide slot 330 adapted to the first positioning guide rail 540 is arranged on an outer wall of the second rod body 300.

Specifically, the quick locking member 500 is provided with a first locking base 513 and a second locking base 514, wherein the first locking base 513 can lock the first rod body 200 by a bolt, the second locking base 514 can lock the second rod body 300 via an eccentric handle 520, and the second rod body 300 is inserted in the first rod body 200. The user controls the locking and releasing of the second locking base 514 to the second rod body 300 by the eccentric handle 520, so that the user can adjust the second rod body 300 to expand and contract in the first rod body 200.

Additionally, a first positioning groove 210 is arranged on the first rod body 200, and the first positioning block 530 is arranged in the first elastic locking sleeve 510 so that the first rod body 200 is aligned with the first locking base 513 through the arrangement of the first positioning groove 210 and the first positioning block 530. When the user rotates the first rod body 200, the first elastic locking sleeve 510 can be rotated synchronously. Moreover, a first positioning guide rail 540 is arranged in the first elastic locking sleeve 510, and a guide slot 330 adapted to the first positioning guide rail 540 is arranged on the second rod body 300, so that the second rod body 300 is aligned with the first elastic locking sleeve 510, and the second rod body 300 can rotate synchronously with the first elastic locking sleeve 510.

Additionally, a limiting sleeve 310 is inserted in the end part of the second rod body 300; the limiting sleeve 310 is arranged in the second hole 512 of the first elastic locking sleeve 510; a limit retaining ring 311 of the limiting sleeve 310 is located in the first hole 511; and the limit retaining ring 311 can abut against the outer wall of the second hole 512 so that the second rod body 300 cannot detach from the first elastic locking sleeve 510. This avoids the second rod body 300 detaching from the first elastic locking sleeve 510 during the telescopic adjustment.

Additionally, during the storage and transportation process, the staff can dissemble the first elastic locking sleeve 510, so that the first rod body 200 and the second rod body 300 can be folded oppositely, which is convenient for storage and transportation.

Referring to FIG. 1-FIG. 11, in an optional solution of the embodiment, the fixed locking member 600 includes a second elastic locking sleeve 610 and a locking bolt 620, wherein a third hole 611 is arranged on the second elastic locking sleeve 610 along its axial direction; a third locking base 612 is arranged on an outer wall of the second elastic locking sleeve 610; and the third locking base 612 is locked by the locking bolt 620.

A second positioning block 630 and a second positioning guide rail 640 are arranged on an inner wall of the second elastic locking sleeve 610; second positioning grooves 410 adapted to the second positioning block 630 are arranged on end parts of the second rod body 300 and the third rod body 400. A guide slot 330 of the second rod body 300 can be adapted to the second positioning guide rail 640, and the guide slot 330 is arranged on an outer wall of the third rod body 400.

Specifically, two third locking bases 612 are arranged on the outer wall of the second elastic locking sleeve 610, and the two third locking bases 612 can separately lock the second rod body 300 and the third rod body 400 by the locking bolt 620.

Additionally, the second elastic locking sleeve 610 is provided with the second positioning block 630 and the second positioning guide rail 640, and the second rod body 300 and the third rod body 400 are provided with the second positioning groove 410 capable of corresponding to the second positioning block 630 and the guide slot 330 capable of corresponding to the second positioning guide rail 640, so that the second rod body 300, along with the second elastic locking sleeve 610, can drive the third rod body 400 to rotate synchronously.

Referring to FIG. 1-FIG. 11, in an optional solution of the embodiment, an adjustable rotating member 110 is arranged in the control handle 100, and one end of the first rod body 200 away from the quick locking member 500 is connected to the adjustable rotating member 110.

The adjustable rotating member 110 includes a locking ring 111, a locking button 112, a locking spring 113, and a locking sleeve 114, wherein the locking sleeve 114 is arranged on the end part of the first rod body 200; the locking ring 111 is sleeved on an outer wall of the locking sleeve 114, and the locking sleeve 114 is provided with a plurality of anti-rotation holes 115. An inner ring of the locking ring 111 is provided with an anti-rotation block 116 adapted to the anti-rotation holes 115, the locking button 112 is arranged on the top of the locking ring 111, and the locking button 112 protrudes from the control handle 100. The locking spring 113 is located at the bottom of the locking ring 111, wherein one end of the locking spring 113 abuts against the locking ring 111, and the other end abuts against an inner wall of the control handle 100. A bearing groove 120 configured for bearing the locking spring 113 is arranged on the inner wall of the control handle 100, and a positioning post 117 is arranged at the bottom of the locking ring 111. Guide slot plates 130 are arranged on the inner wall of the control handle 100, and the locking ring 111 is arranged between two guide slot plates 130, so that the locking ring 111 can slide up and down along a sliding groove between the two guide slot plates 130.

Specifically, when the user needs to adjust and rotate the direction of the lawn mower head 700, the user presses the locking button 112, the locking button 112 drives the locking ring 111 to move downward, and the locking ring 111 compresses the locking spring 113. At this time, the anti-rotation block 116 on the locking ring 111 can detach from the anti-rotation hole 115 on the locking sleeve 114. At this time, the user can rotate the first rod body 200, so that the first rod body 200 rotates relative to the control handle 100, and then the locking button 112 is released, and the locking ring 111 is reset under the action of the locking spring 113. Therefore, the anti-rotation block 116 on the locking ring 111 can be snapped into the anti-rotation hole 115 on the locking sleeve 114 to fix the locking sleeve 114, so that the first rod body 200 cannot rotate.

The locking sleeve 114 is provided with a plurality of anti-rotation holes 115. According to the demand, the user can rotate the first rod body 200 by 30 degrees, 45 degrees, 60 degrees, and 90 degrees, etc., so that the user can process different vegetation.

The present disclosure provides a lawn mower, including the lawn mower body structure.

Specifically, the lawn mower provided by the embodiment has advantages of the above lawn mower body structure compared with the prior art, which will not be repeated herein.

Finally, it should be noted that: the above embodiments are only used to illustrate the technical solutions of the present disclosure, and not to restrict them. Although the present disclosure is described in detail with reference to the foregoing embodiments, it should be understood by persons of ordinary skill in the art that they may still modify the technical solutions described in the foregoing embodiments or make equivalent substitutions for some or all of the technical features; and these modifications or substitutions do not take the essence of the corresponding technical solutions out of the scope of the technical solutions of the embodiments of the present disclosure.

1. A lawn mower body structure, comprising: a control handle, a first rod body, a second rod body, and a third rod body, wherein
one end of the first rod body is connected to the control handle, and another end is connected to the second rod body via a quick locking member;
one end of the second rod body away from the first rod body is connected to the third rod body via a fixed locking member; and
one end of the third rod body away from the second rod body is able to connect to a lawn mower head of the lawn mower.

2. The lawn mower body structure according to claim 1, wherein the quick locking member comprises a first elastic locking sleeve and an eccentric handle;
the first elastic locking sleeve is provided with a first hole and a second hole, wherein the first hole and the second hole are communicated and are capable of passing through the first elastic locking sleeve in an axial direction of the first elastic locking sleeve, and a diameter of the first hole is larger than a diameter of the second hole;
the first rod body is inserted in the first hole; the second rod body is inserted in the second hole; and an outer diameter of the second rod body is not larger than an inner diameter of the first rod body; and
a first locking base is arranged on an outer wall of the first elastic locking sleeve located at the first hole, and a second locking base is arranged on an outer wall of the first elastic locking sleeve located at the second hole, wherein two sides of the first locking base are locked by a bolt, and the eccentric handle is mounted on the second locking base by the bolt, so that the eccentric handle is able to control locking of the second locking base.

3. The lawn mower body structure according to claim 2, wherein a limiting sleeve is arranged on one end of the second rod body inserted in the second hole; a limit retaining ring is arranged on an outer ring of the limiting sleeve; an outer diameter of the limit retaining ring is larger than an inner diameter of the second hole; and the limit retaining ring is located in the first hole.

4. The lawn mower body structure according to claim 3, wherein a limit snapping hole is arranged on a side wall of the second rod body, and the limit retaining ring is provided with an elastic snapping block capable of snapping with the limit snapping hole.

5. The lawn mower body structure according to claim 4, wherein a first positioning block and a first positioning guide rail are arranged on an inner wall of the first elastic locking sleeve;
a first positioning groove adapted to the first positioning block is arranged on an end part of the first rod body; and
a guide slot adapted to the first positioning guide rail is arranged on an outer wall of the second rod body.

6. The lawn mower body structure according to claim 1, wherein the fixed locking member comprises a second elastic locking sleeve and a locking bolt;
a third hole is arranged on the second elastic locking sleeve along its axial direction; a third locking base is arranged on an outer wall of the second elastic locking sleeve; and the third locking base is locked by the locking bolt.

7. The lawn mower body structure according to claim 6, wherein a second positioning block and a second positioning guide rail are arranged on an inner wall of the second elastic locking sleeve;
second positioning grooves adapted to the second positioning block are arranged on end parts of the second rod body and the third rod body; and
a guide slot of the second rod body is capable of being adapted to the second positioning guide rail, and the guide slot is arranged on an outer wall of the third rod body.

8. The lawn mower body structure according to claim 1, wherein an adjustable rotating member is arranged in the control handle, and one end of the first rod body away from the quick locking member is connected to the adjustable rotating member.

9. The lawn mower body structure according to claim 8, wherein the adjustable rotating member comprises a locking ring, a locking button, a locking spring, and a locking sleeve;
the locking sleeve is arranged on an end part of the first rod body; the locking ring is sleeved on an outer wall of the locking sleeve; the locking sleeve is provided with a plurality of anti-rotation holes; and an inner ring of the locking ring is provided with an anti-rotation block adapted to the anti-rotation holes;
the locking button is arranged on a top of the locking ring, and the locking button protrudes from the control handle;
the locking spring is located at a bottom of the locking ring, wherein one end of the locking spring abuts against the locking ring and another end abuts against an inner wall of the control handle;
a bearing groove configured for bearing the locking spring is arranged on the inner wall of the control handle, and a positioning post is arranged at a bottom of the locking ring; and
guide slot plates are arranged on the inner wall of the control handle, and the locking ring is arranged between two guide slot plates, so that the locking ring is able to slide up and down along a sliding groove between the two guide slot plates.

10. A lawn mower, comprising the lawn mower body structure according to claim 1.

11. The lawn mower according to claim 10, wherein the quick locking member comprises a first elastic locking sleeve and an eccentric handle;
the first elastic locking sleeve is provided with a first hole and a second hole, wherein the first hole and the second hole are communicated and are capable of passing through the first elastic locking sleeve in an axial direction of the first elastic locking sleeve, and a diameter of the first hole is larger than a diameter of the second hole;
the first rod body is inserted in the first hole; the second rod body is inserted in the second hole; and an outer diameter of the second rod body is not larger than an inner diameter of the first rod body; and
a first locking base is arranged on an outer wall of the first elastic locking sleeve located at the first hole, and a second locking base is arranged on an outer wall of the first elastic locking sleeve located at the second hole, wherein two sides of the first locking base are locked by a bolt, and the eccentric handle is mounted on the second locking base by the bolt, so that the eccentric handle is able to control locking of the second locking base.

12. The lawn mower according to claim 11, wherein a limiting sleeve is arranged on one end of the second rod body inserted in the second hole; a limit retaining ring is arranged on an outer ring of the limiting sleeve; an outer diameter of the limit retaining ring is larger than an inner diameter of the second hole; and the limit retaining ring is located in the first hole.

13. The lawn mower according to claim 12, wherein a limit snapping hole is arranged on a side wall of the second rod body, and the limit retaining ring is provided with an elastic snapping block capable of snapping with the limit snapping hole.

14. The lawn mower according to claim 13, wherein a first positioning block and a first positioning guide rail are arranged on an inner wall of the first elastic locking sleeve;
a first positioning groove adapted to the first positioning block is arranged on an end part of the first rod body; and
a guide slot adapted to the first positioning guide rail is arranged on an outer wall of the second rod body.

15. The lawn mower according to claim 10, wherein the fixed locking member comprises a second elastic locking sleeve and a locking bolt;
a third hole is arranged on the second elastic locking sleeve along its axial direction; a third locking base is arranged on an outer wall of the second elastic locking sleeve; and the third locking base is locked by the locking bolt.

16. The lawn mower according to claim 15, wherein a second positioning block and a second positioning guide rail are arranged on an inner wall of the second elastic locking sleeve;
second positioning grooves adapted to the second positioning block are arranged on end parts of the second rod body and the third rod body; and
a guide slot of the second rod body is capable of being adapted to the second positioning guide rail, and the guide slot is arranged on an outer wall of the third rod body.

17. The lawn mower according to claim 10, wherein an adjustable rotating member is arranged in the control handle, and one end of the first rod body away from the quick locking member is connected to the adjustable rotating member.

18. The lawn mower according to claim 17, wherein the adjustable rotating member comprises a locking ring, a locking button, a locking spring, and a locking sleeve;
the locking sleeve is arranged on an end part of the first rod body; the locking ring is sleeved on an outer wall of the locking sleeve; the locking sleeve is provided with a plurality of anti-rotation holes; and an inner ring of the locking ring is provided with an anti-rotation block adapted to the anti-rotation holes;
the locking button is arranged on a top of the locking ring, and the locking button protrudes from the control handle;
the locking spring is located at a bottom of the locking ring, wherein one end of the locking spring abuts against the locking ring and another end abuts against an inner wall of the control handle;
a bearing groove configured for bearing the locking spring is arranged on the inner wall of the control handle, and a positioning post is arranged at a bottom of the locking ring; and
guide slot plates are arranged on the inner wall of the control handle, and the locking ring is arranged between two guide slot plates, so that the locking ring is able to slide up and down along a sliding groove between the two guide slot plates.
